(19) United States
(12) Patent Application Publication
(10) Pub. No.: US 2005/0159496 A1
(43) Pub. Date: Jul. 21, 2005

(54) Polypropylene foam and foam core structure

(76) Inventors: John D Bambara, Osterville, MA (US); Robert W. Beckwith, Cummaquid, MA (US); Robert Hooper, Sagamore Beach, MA (US); Robert Hurley, Centerville, MA (US)

Correspondence Address: Paul D Durkee;Daly Crowley & Mofford, 275 Turnpike Street, Suite 101, Canton, MA, 02021-2354, US

(21) Appl. No.: 10/506,856

(22) PCT Filed: Mar. 7, 2003
(86) PCT No.: PCT/US03/06975

Related U.S. Application Data
(60) Provisional application No. 60/362,728, filed on Mar. 7, 2002.
(60) Provisional application No. 60/362,819, filed on Mar. 8, 2002.

(51) Int. Cl. C08J 9/00

(52) U.S. Cl. 521/50

(57) ABSTRACT

One or more external surfaces of an extruded foam are coated by co-extruding a skin of polymer on the surface to reduce the diffusion the foaming gases out of the cells of the solidifying polymer foam. The sealing effect can involve coating one side of the extruded foam (AB foam) or both sides (ABA form). The skins can be solid or foamed. Alternatively, a cylinder is formed from an annular die and, preferably, a cylindrical cooling mandrel. By extruding and drawing the cylinder of foam onto a cooled cylindrical mandrel, which expands the diameter of the cylinder, the optimum physical properties of the structure can be achieved. This is because the foam structure is stretched in longitudinal and lateral directions. Preferable, the foaming polymer has “inherent melt strength” and “strain hardening” so that the foam cells are more consistent in size and shape. The preferred polymers are polypropylene or polystyrene.

### CROSS-REFERENCE TO RELATED APPLICATIONS

This application claims the benefit under 35 U.S.C. §119(e) of prior U.S. Provisional Application No. 60/362,728, filed Mar. 7, 2002 and prior U.S. Provisional Application No. 60/362,819 filed Mar. 8, 2002; both of which are hereby incorporated by reference.

### STATEMENT REGARDING FEDERALLY SPONSORED RESEARCH OR DEVELOPMENT

This invention has been created without the sponsorship or funding of any federally sponsored research or development program.

### FIELD OF THE INVENTION

This invention involves a co-extrusion method for forming a foam core polymer laminate and the laminate.

### BACKGROUND OF THE INVENTION

This invention identifies the product and process to produce a polypropylene foam and/or a multi-layered composite structure utilizing a foamed polypropylene core with additional layers of foamed or solid polypropylene or other thermoplastic or thermoset materials. The structure can be in the form of a flat sheet, tubular extrusion, or geometric or irregular profile shape. Though the foam or foamed core of the structure can be foamed with chemical blowing agents, or physical blowing agents of either hydrocarbon and/or inorganic types, or combination of either types and/or both types, the preferred foaming agent is carbon dioxide with a nucleating agent. The end use of the composite structure will predicate if a foam sheet alone or a structures with the numbers of and the composition of the layers in the structure.

References cited:

U.S. Patents

| | | | | | |
|---|---|---|---|---|---|
| #6,350,828 | #06326409 | #06251319 | #06174930 | #06166096 | #06103153 |
| #06096417 | #06103153 | #06096417 | #06077878 | #06077875 | #06051617 |
| #05929129 | #05928776 | #05902858 | #05747549 | #05616627 | #05567742 |
| #05545351 | #05527573 | #05348795 | #05304579 | #05286428 | #05281376 |
| #05252269 | #05180751 | #05149579 | #05116881 | #05082869 | #05073444 |
| #04940736 | #06326409 | #06306960 | #06251319 | #06174930 | #06166096 |
| #06103153 | #06096417 | #06077878 | #06077875 | #05929129 | #05928776 |
| #05902858 | #05747549 | #05616627 | #05866053 | #05334356 | |

European Patents

| | | | | | |
|---|---|---|---|---|---|
| #0916465 | #0841155 | #0470380 | #0625168 | #0700939 | #0601455 |
| #0480456 | #0450342 | #0450342 | #0480456 | #0450342 | #0481306 |
| #0520028 | #0337584 | #0263989 | #0229461 | #0178283 | #0178282 |
| #0291764 | | | | | |

Polypropylene is known for its stiffness and strength, while providing a low cost polymer for construction of parts and artifacts by known processes in plastics fabrication such as injection molding, blow molding, extrusion, thermoforming, etc. Polypropylene [PP] is also known for higher temperature performance than other polymers such as polyethylene. Similarly grades of polypropylene are available for food contact. Polypropylene is also transparent to microwaves. These properties makes polypropylene viable for many applications for parts and artifacts of construction in varied industries such as automotive, industrial, medical, athletic, and also for use in food packaging.

Polypropylene has been used in many applications, as a neat polymer and as a filled composition. Though some polypropylene foams produced, they have been limited in the achievable density and uniformity of cell. This is indicated by the voids present and appearance of gas pockets in a solid matrix instead of a continuous foam structure in prior polypropylene foams produced with chemical blowing agents. When physical blowing agents were used, foams could not be produced economically because of the high cost of the foamable polypropylenes used. However, what is novel in this invention is the use of carbon dioxide alone or with nitrogen to produce fine celled foam at a 30% to 60% weight reduction with a blend of polypropylenes. In this invention it is preferred to have an endothermic nucleating agent assist in the formation of uniform cell structure.

It has been demonstrated in the industry that polypropylene can be processed, formed, and/or foamed in the various processes and types of equipment that are utilized with polymeric materials such as LDPE, HDPE, EVA, PET, etc. For example, Takaoka describes the use of a high molecular weight polypropylene with high melt tension in U.S. Pat. No. 6,350,828 for superior moldability of a solid polypropylene. There are numerous examples which depict the use polypropylene in foam applications. Additional examples, including but not limited to the following, are U.S. patents in which polypropylene is identified, but not being limited to, as being moldable, formable, or foamable or as being foamed as a sheet, article, molded piece, or construction. These examples indicate the use of polypropylene as follows:
In-mold foaming article of polypropylene resin composition U.S. Pat. No. 06,326,409
Method of forming a thermoformable polypropylene foam sheet U.S. Pat. No. 06,251,319
Foamable polypropylene polymer U.S. Pat. No. 06,174,930
Pre-expanded particles of polypropylene resin, process for producing the same and process for producing in-mold foamed articles therefrom U.S. Pat. No. 06,166,096
Production of foamed low-density polypropylene by rotational molding U.S. Pat. No. 06,103,153
Composite material having polypropylene resin molded body and polypropylene resin foamed body and method of producing same U.S. Pat. No. 06,096,417
Foam made from modified polypropylene resin and process for the production thereof U.S. Pat. No. 06,077,878
Foamed and expanded beads of polypropylene resin for molding U.S. Pat. No. 06,077,875
Foamed particles of modified polypropylene resin and method of preparing same U.S. Pat. No. 06,051,617
Cross linked foamable compositions of silane-grafted, essentially linear polyolefins blended with polypropylene U.S. Pat. No. 05,929,129
Composite material having polypropylene foam layer U.S. Pat. No. 05,928,776
Modified polypropylene resin, foam made thereof and processes for the preparation of them U.S. Pat. No. 05,902,858
Foamed particles of polypropylene homopolymer and molded article of the foamed particles U.S. Pat. No. 05,747,549
Polypropylene resin composition, polypropylene resin foamed material and process for producing the same U.S. Pat. No. 05,616,627
Dimensionally-stable polypropylene foam expanded with inorganic blowing agents U.S. Pat. No. 05,567,742
Use of stearic acid esters of polypropylene glycol to control foam U.S. Pat. No. 05,545,351
Extruded closed-ell polypropylene foam U.S. Pat. No. 05,527,573
Process for making a dimensionally-stable open-cell polypropylene foam with organic blowing agents U.S. Pat. No. 05,348,795
Method for molding polypropylene resin U.S. Pat. No. 05,304,579
Polypropylene resin foamed sheet for thermoforming and process for producing the same U.S. Pat. No. 05,286,428
Method for producing polypropylene resin article having skin material lined with foamed layer U.S. Pat. No. 05,281,376
Method for molding polypropylene resin U.S. Pat. No. 05,252,269
Polypropylene foam sheets U.S. Pat. No. 05,180,751
Polypropylene foam sheets U.S. Pat. No. 05,149,579
Polypropylene foam sheets U.S. Pat. No. 05,116,881
Cross-linked polypropylene compositions suitable for the preparation of foamed materials U.S. Pat. No. 05,082,869
Molded polypropylene foam tire cores U.S. Pat. No. 05,073,444
Production of low density polypropylene foam U.S. Pat. No. 04,940,736
In-mold foaming article of polypropylene resin composition U.S. Pat. No. 06,306,409
Articles formed from foamable polypropylene polymer U.S. Pat. No. 06,306,960
Method of forming a thermoformable polypropylene foam sheet U.S. Pat. No. 06,251,319
Foamable polypropylene polymer U.S. Pat. No. 06,174,930
Pre-expanded particles of polypropylene resin, process for producing the same and process for producing in-mold foamed articles therefrom U.S. Pat. No. 06,166,096
Production of foamed lowly polypropylene by rotational molding U.S. Pat. No. 06,103,153
Composite material having polypropylene resin molded body and polypropylene resin foamed body and method of producing same U.S. Pat. No. 06,096,417
Foam made from modified polypropylene resin and process for the production thereof U.S. Pat. No. 06,077,878
Foamed and expanded beads of polypropylene resin for molding U.S. Pat. No. 06,077,875
Cross linked foamable compositions of silane-grafted, essentially linear polyolefins blended with polypropylene U.S. Pat. No. 05,929,129
Composite material having polypropylene foam layer U.S. Pat. No. 05,928,776
Modified polypropylene resin, foam made thereof and processes for the preparation of them U.S. Pat. No. 05,902,858
Foamed particles of polypropylene homopolymer and molded article of the foamed particles U.S. Pat. No. 05,747,549
Polypropylene resin composition, polypropylene resin foamed material and process for producing the same U.S. Pat. No. 05,616,627

In addition, there are U.S. patents that indicate methods to produce microcellular and supermicrocellular foamed materials which could include the use of polypropylene. Examples of these patents include, but are not limited to:
Method for providing a continuos processing of microcellular and supermicrocellular materials U.S. Pat. No. 5,866,053
Supermicrocellular Foamed materials U.S. Pat. No. 5,334,356

There are also foreign patents issued which indicate the use of polypropylene as a solid or foam in the process or as a completed sheet, foam, mold piece or construction. Examples of the use of polypropylene in European Patents Granted include but are not limited to:
Composite polypropylene material having molded and foamed layer and method of producing same U.S. Pat. No. 0,916,465
Composite material having polypropylene foam layer U.S. Pat. No. 0,841,155
Polypropylene molding composition U.S. Pat. No. 0,470,380
A PROCESS FOR MAKING A DIMENSIONALLY-STABLE POLYPROPYLENE FOAM EXPANDED WITH INORGANIC BLOWING AGENTS U.S. Pat. No. 0,625,168
Expanded polypropylene particle U.S. Pat. No. 0,700,939
Polypropylene composition for the manufacture of calendered sheets U.S. Pat. No. 0,601,455
Method for producing polypropylene resin article having skin material lined with foamed layer U.S. Pat. No. 0,480,456
Cross linked polypropylene compositions suitable for the manufacture of foamed articles. U.S. Pat. No. 0,450,342
Method for producing polypropylene resin article having skin material lined with foamed layer U.S. Pat. No. 0,480,456
Cross linked polypropylene compositions suitable for the manufacture of foamed articles. U.S. Pat. No. 0,450,342
Method for molding polypropylene resin. U.S. Pat. No. 0,481,306 POLYPROPYLENE FOAM SHEETS. U.S. Pat. No. 0,520,028
Process for the production of expanded particles of a polypropylene resin. U.S. Pat. No. 0,337,584
Process for production of foamed molded articles of polypropylene resin. U.S. Pat. No. 0,263,989
Foamable composition comprising polypropylene, and cellular products thereof. U.S. Pat. No. 0,229,461
Rigid material of expanded polypropylene and process for preparing the same. U.S. Pat. No. 0,178,283
Expanded polypropylene films and process for preparing them. U.S. Pat. No. 0,178,282
Method of manufacturing foamed polypropylene resin sheet. U.S. Pat. No. 0,291,764

However, having acknowledged prior art and developments therein, the utilization of the prior art does not produce the unique features of the polypropylene foam equivalent to the present invention.

These and other difficulties experienced with the prior art devices have been obviated in a novel manner by the present invention.

It is, therefore, an outstanding object of the present invention to provide a foam core laminate structure of polypropylene or polystyrene which is effective and durable and yet economically reasonable.

Another object of this invention is to provide a method for manufacturing a foam core laminate structure of polypropylene or polystyrene which is effective and durable and yet economically reasonable.

A further object of the present invention is to provide a foam core laminate structure of polypropylene or polystyrene which can be used to manufacture structures that are effective and durable and yet economically reasonable.

It is a further object of the invention to provide a foam core structure which is capable of being manufactured of high quality and at a low cost, and which is capable of providing a long and useful life with a minimum of maintenance.

With these and other objects in view, as will be apparent to those skilled in the art, the invention resides in the combination of parts set forth in the specification and covered by the claims appended hereto, it being understood that changes in the precise embodiment of the invention herein disclosed may be made within the scope of what is claimed without departing from the spirit of the invention.

### BRIEF SUMMARY OF INVENTION

One or more external surfaces of an extruded foam are coated by co-extruding a skin of polymer on the surface to reduce the diffusion the foaming gases out from the cells of the solidifying polymer foam. The skin or skins is/are applied inside of the co-extrusion die while the polymer gas mixture is at high pressure and the gas is dissolved in the polymer. The sealing effect of this can be accomplished by simply coating one side of the extruded foam (the AB form) The effect is much more dramatic if both surfaces of the extruded foam are co-extruded with skins of polymer (the ABA form). The skins can be solid or can themselves be foamed. It is preferred that the density reduction of the skin layers will be less than the density reduction of the main foam layer. The skins can be foamed by chemical or physical foaming agent or by combination of chemical and physical foaming agents. Even more effective, is a process involving an annular die and, preferably, a cylindrical cooling mandrel. The cylindrical co-extrusion seals even the edges of the laminate. By extruding and drawing the cylinder of foam onto a cooled cylindrical mandrel, which expands the diameter of the cylinder, the maximum physical properties of the structure can be achieved. This is because the foam structure is stretched in longitudinal and lateral directions. Preferable, the foaming polymer has and exhibits “inherent melt strength” and “strain hardening” so that the foam cells are more consistent in size and shape. The preferred polymers are polypropylene or polystyrene.

It would generally be desirable to develop foam plastic structures of polypropylene, especially, extruded foam and skin laminates. Foams formed from polypropylene would be expected to have improved properties at low cost compared to polyethylene and other foams particularly in stiffness and thermal resistance. However it is very difficult to actually manufacture foams from polypropylene. Attempts to extrude polypropylene foams using chemical blowing agents have resulted in foams that have very inconsistent cell formation. Attempts at using physical blowing agents have generally been unsuccessful because the high pressure and rapid diffusion of physical blowing agents such as carbon dioxide or nitrogen at the high processing temperature of polypropylene. Foaming of polypropylene is further complicated by the low inherent melt strength as exhibited by lack of “strain hardening”. These factors result in inconsistent and collapsed or open cells.

It is known in the industry that the melt strength problem can be addressed by modifying the polymer with branching or cross linking of the base polymer. The modification of the polymer in this manner produces a polypropylene that exhibits strain hardening. Polymers of this type are commercially available. The cost of these modified polymers is significantly increased over standard PP.

The issue of rapid diffusion is most evident in the use of atmospheric gases. It is desirable to use Nitrogen or Carbon Dioxide for low cost and environmental concerns. CO2 produces a stiffer foam than hydrocarbon foaming agents due to lack of solubility in the polymer. However low solubility and high pressure at processing temperature complicate their use.

The essence of this invention is to develop techniques to reduce the diffusion rates of the physical blowing gases out of the molten extruded material so that the gases remain in the foamed material while the polymer is solidifying and so that the gases are captured in the solidifying polymer.

The key element of this invention is the idea that one or more external surfaces of the extruded foam are coated by co-extruding a layer of polymer on the surface to reduce the diffusion the foaming gases out for the cells of the solidifying polymer foam. The layer or layers are applied inside of the die while the polymer gas mixture is at high pressure and the gas is dissolved in the polymer. The sealing effect of this can be accomplished by simply coating one side of the extruded foam (the AB form). The effect is much more dramatic if both surfaces of the extruded foam are co-extruded with layers of polymer (the ABA form).

The layers can be solid or can themselves be foamed. It is preferred that the density reduction of the skin layers will be less than the density reduction of the main foam layer. The layers can be foamed by chemical or physical foaming agent or by combination of chemical and physical foaming agents. Selection of polymer and density reduction of the skin layers is critical in the quality of the overall structure.

A process involving an annular die and cylindrical cooling mandrel is preferred. By extruding and drawing the cylinder of foam onto a cooled cylindrical mandrel, which expands the diameter of the cylinder, the maximum physical properties of the structure can be achieved. This is because the foam structure is stretched in longitudinal and lateral directions.

The process described is not limited to polypropylene. It has been demonstrated to work well with other polymers, specifically polystyrene.

### BRIEF DESCRIPTION OF THE DRAWINGS

The invention can be best understood by reference to the drawing, in which:

FIG. 1 is a front elevation view of a skin-core-skin (ABA) laminate embodying the principles of the present invention;

FIG. 2 is a plan view of a production line for co-extruding a cylinder, expanding the cylinder, slitting the cylinder, flattening the resulting product and drawing the product through rollers, with the cylinder being shown as a sectional view along line II-II of FIG. 3, all embodying the principles of the present invention;

FIG. 3 is a front elevation view of a portion of the production line shown in FIG. 2 for co-extruding a cylinder, expanding the cylinder, slitting the cylinder, flattening the resulting product and drawing the product through rollers, all embodying the principles of the present invention;

FIG. 4 is a diagrammatic view of the manner by which the production line shown in FIG. 2 co-extrudes a cylinder, expands the cylinder over a cooled mandrel, and shows the slitting blade, all embodying the principles of the present invention;

FIG. 5 is a bottom view of the co-extruded cylinder as it is expanded, and then slit and flattened;

FIG. 6 is a diagrammatic elevation view of a skin-core-skin (ABA) laminate being co-extruded as a flat extrudate, and then expanding in thickness; and

FIG. 7 is a diagrammatic cross-sectional elevation view of a skin-core-skin (ABA) laminate being co-extruded as a cylinder, and then expanding in thickness, and then expanding in diameter.

### DETAILED DESCRIPTION OF THE INVENTION

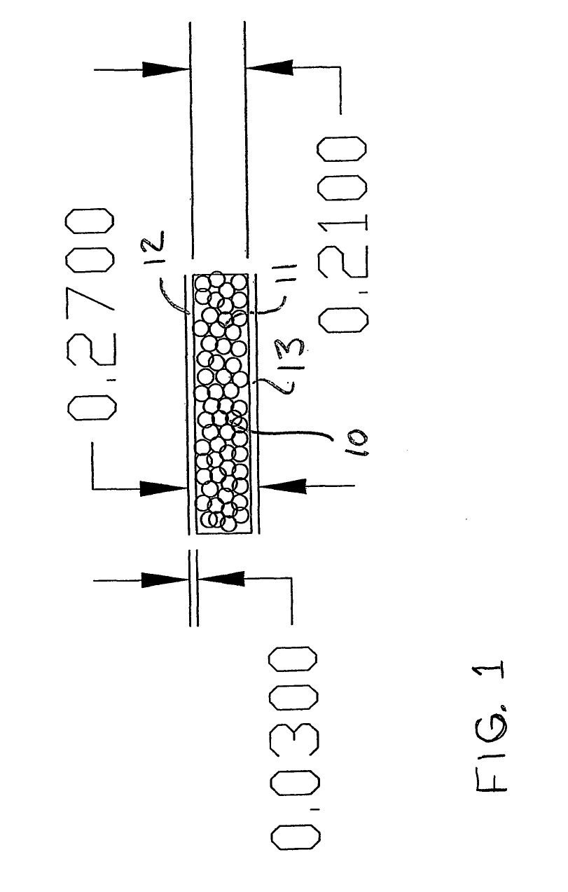

The principles of the invention can be best understood by reference to the drawing. FIG. 1. is a front elevation of a skin-core-skin (ABA) laminate embodying the principles of the present invention. The laminate, generally designated by the numeral 10, is formed of a foamed core 11, and at least one 12 one side of the core 11. This is referred to as an AB construction. In the preferred embodiment, the laminate would also have a second skin 13 coating the opposite side of the core from the first skin 12.

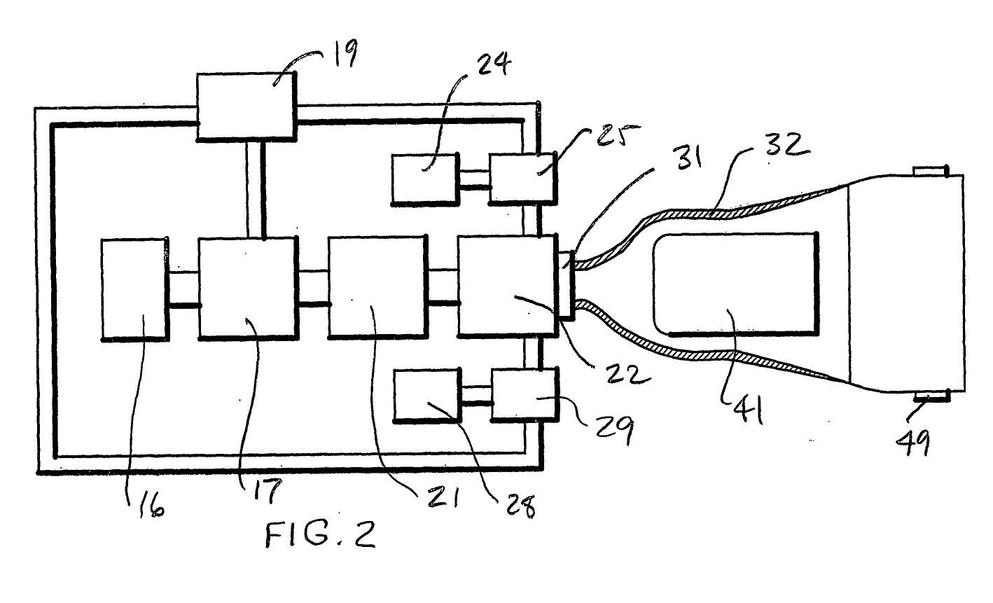

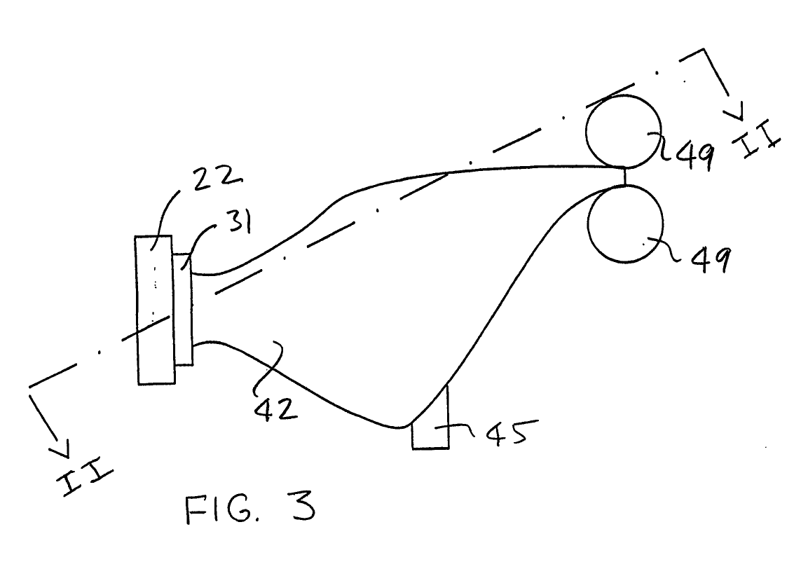

FIG. 2 is a plan view of a production line for co-extruding a cylinder, expanding the cylinder, slitting the cylinder, flattening the resulting product and drawing the product through rollers, with the cylinder being shown as a sectional view along line II-II of FIG. 3, all embodying the principles of the present invention. The core polymer 15 is fed from a core polymer reservoir 16 to a mixer 17 where it is combined, under high-pressure, with physical blowing gas 18 from a high-pressure gas source 19. The high-pressure mixture is then fed to a temperature control mixer 21 and then to a core extruding head 22. Skin polymer 23 is fed from a skin polymer reservoir 24 into a pressurizer 25. In the pressurizer 25, the skin polymer 23 can optionally be mixed with blowing gas, such as, optionally, blowing gas 18 from gas source 19. The resulting product is then fed to the co-extrusion head 22, where it will be co-extruded to form a skin on the foamed core 11. Optionally, a second skin polymer 27 can be fed from a skin polymer reservoir 28 into a pressurizer 29. In the pressurizer 29, the second skin polymer 27 can be optionally mixed with blowing gas such as, optionally, blowing gas 18 from gas source 19. The resulting product can optionally be fed to the co-extrusion head 22, where it will be co-extruded to form a second skin on the opposite side of the foamed core from the first skin.

In the preferred embodiment, the laminate leaves the co-extrusion exit 31 of the co-extrusion head 22 in the form of a cylinder 32, with the cylinder enter wall 11 formed of the core polymer 15, the first skin material 12 coating the outside surface of the cylinder and the second skin material 23 coating inside surface of the cylinder. Once the extrudate leaves the core of extrusion exit 31 and is exposed to atmospheric pressure, the blowing gas forms bubbles or cells and begins to expand the cells. If there is gas in the skin lawyers, this also occurs there. If the skin layers were not present, the temperature and diffusivity of the core polymer 15, which is preferentially polypropylene, would allow the blowing gas to diffuse out of the cells so that they would not be fully expanded or what expanded a very erratic and unpredictable manner. However, the presence of the skin, especially if it is on both the inside in the outside surfaces all the core, seals the surfaces to prevent leakage of the blowing gas from the foamed and to allow the cells to form into relatively large relatively consistently shaped in sized bubbles.

In the preferred embodiment, while the co-extrudate is formed and while it is still plastic, the co-extrudate is drawn by rollers 49 over a cooled mandrel 41 which blows air into the interior of the cylinder and causes the cylinder to expand outward to increase its diameter. This can be seen in the section portion of the figure. Once the cylinder is fully expanded in diameter, is split longitudinally on the bottom, flattened, and then fed to flattening rolls 49 which flattened the laminate and draw it.

FIG. 3 is a front elevation view of a portion of the production line shown in FIG. 2 for co-extruding a cylinder, expanding the cylinder, slitting the cylinder, flattening the resulting product and drawing the product through rollers, all embodying the new model to principles of the present invention. The cylinder 42 exits the extrusion exit 31 of the extrusion head 22 and is expanded in diameter. Once the cylinder 42 is expanded, the cylinder 42 is slit longitudinally by slitting blade 45. The cylinder 42 is then flattened and fed to flattening and drawing rolls 49.

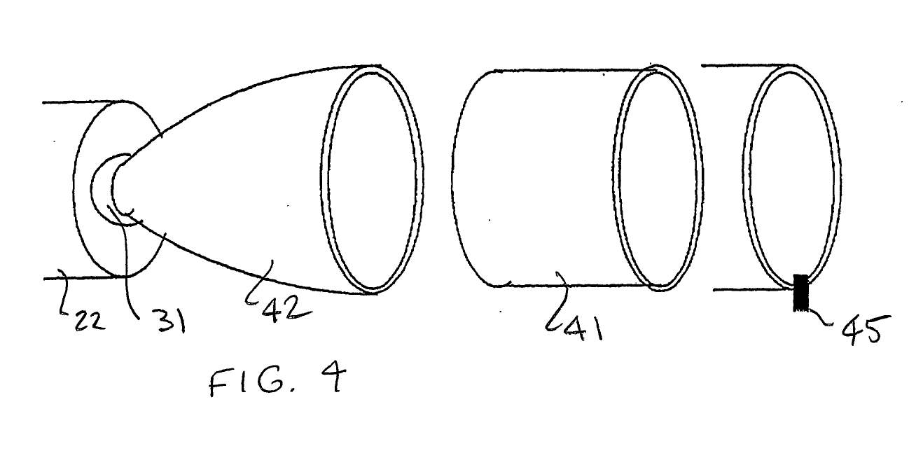

FIG. 4 is a diagrammatic view of the manner by which the production line shown in FIG. 2 co-extrudes a cylinder, expands the cylinder over a cooled mandrel, and shows the slitting blade, all embodying the principles of the present invention. The cylinder 42 exits the extrusion exit 31 of the extrusion head 22 and is expanded in diameter by mandrel 41. Once the cylinder 42 is expanded, the cylinder 42 is slit longitudinally by slitting blade 45.

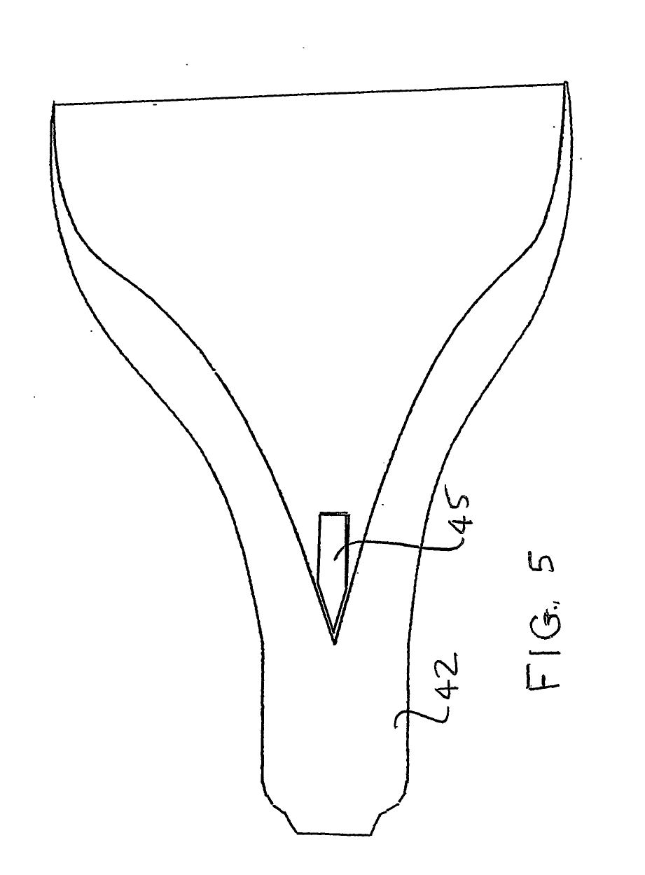

FIG. 5 is a bottom view of the co-extruded cylinder as it is expanded, and then slit and flattened. The cylinder 42 exits the extrusion exit 31 of the extrusion head 22 and is expanded in diameter. Once the cylinder 42 is expanded, the cylinder 42 is slit longitudinally by slitting blade 45. The cylinder 42 is then flattened and fed to flattening and drawing rolls 49.

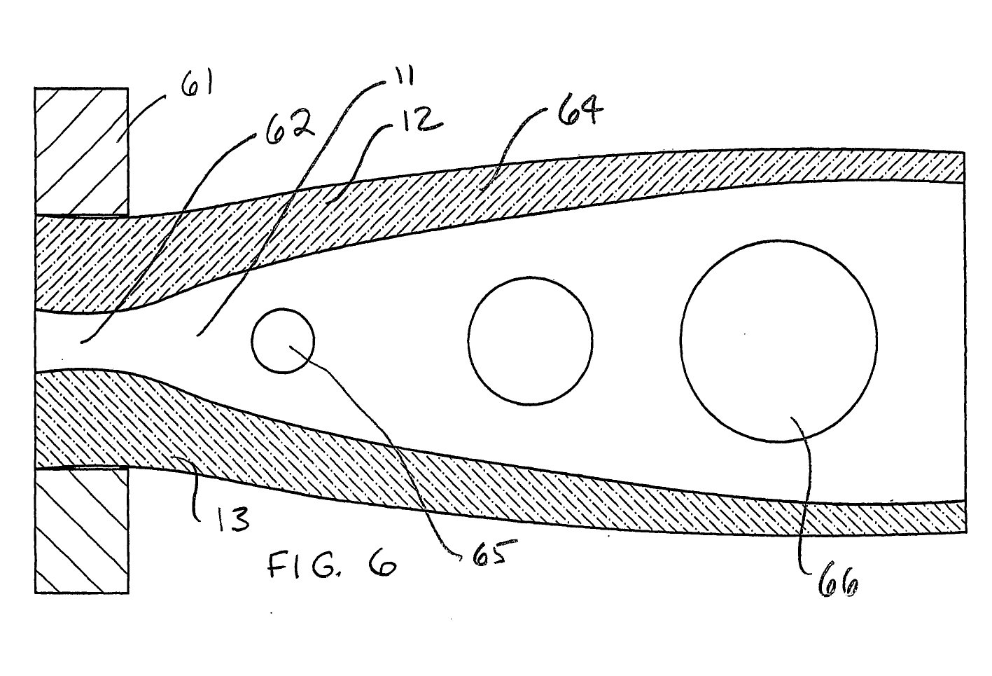

FIG. 6 is a diagrammatic elevation view of a skin-core-skin (ABA) laminate being co-extruded as a flat extrudate, and then expanding in thickness. The co-extruding exit 61 has an elongated mouth 62 with the top skin polymer 12 on the top of the mouth 62, the bottom skin polymer 13 on the bottom of the mouth 62, and the core polymer 11 in the middle of the mouth 62. The co-extrudate 64 leaves the high-pressure zone of the extruder and exits the extruder mouth 62 into atmospheric pressure. At that point, the blowing gas 18 within the core polymer 11 expands and forms small bubbles or cells 65. This causes the co-extrudate up 64 to grow in thickness between the two skin layers 12 and 13. Normally, at the high temperatures necessary to extrude polymers such as polyurethane or polystyrene, if atmospheric gases such as carbon dioxide or nitrogen are used as physical blowing agents, the diffusivity of the polymers would allow the gases to escape to the atmosphere and would result in ineffective foaming, undersized bubbles, and non-uniformity and unpredictability of the bubble formation and size. However, because of the presence of the skins 12 and 13 on one or both sides of the co-extrudate 64, the gases are sealed into the core polymer 11 while the core polymer 11 is molten, so that extremely desirable cell formation, as to size, uniformity, and shape, is achieved. In the preferred embodiment, the core polymer 15 is selected to have a high degree of strain hardening so that, as the bubble 66 grows to its optimum size, strain hardening causes the bubble wall to have reduced stretching capability to that further expansion of the bubble above the optimum size is restricted or stopped. Thus, by carefully selecting the core polymer 15 and the effective blowing gas, very uniform cells of predictable size can be achieved. The laminate 10 itself can be exposed to varying degrees of tension in order to control the thickness of the laminate, control the thickness of the skin surfaces and to affect the properties of the laminate by exposing the layers to stretching and polymer orientation.

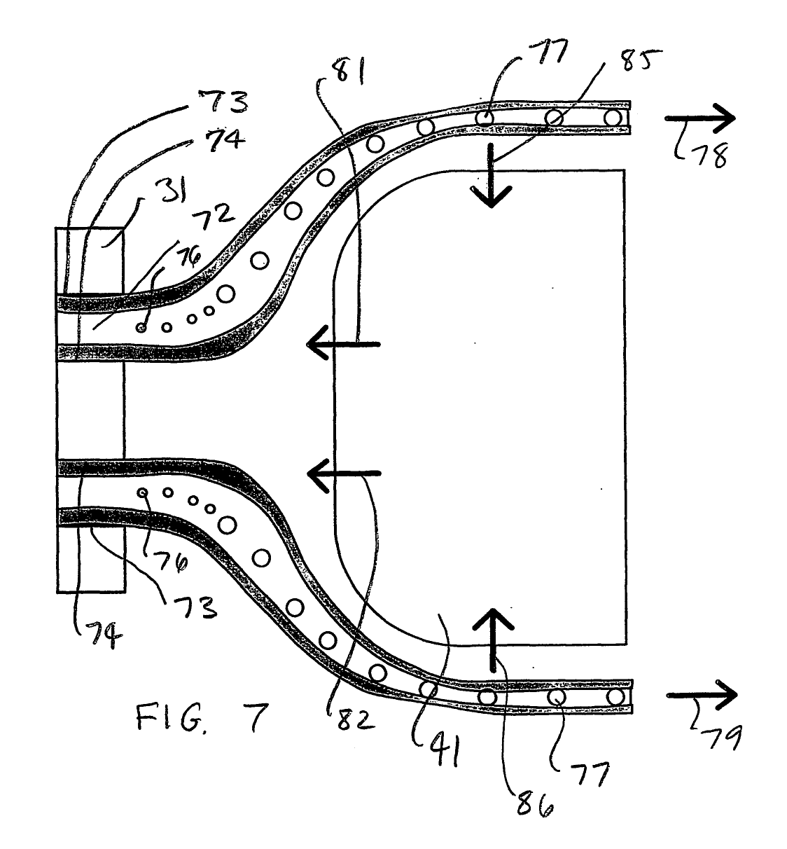

FIG. 7 is a diagrammatic cross-sectional elevation view of a skin-core-skin (ABA) laminate being co-extruded as a cylinder, and then expanding in thickness, and then expanding in diameter. The co-extruding exit 41 has a circular mouth 72 with the top skin polymer 12 on the outer edge of 73 of the mouth 72, the bottom skin polymer 13 on the inner edge 74 of the mouth 72, and the core polymer 11 in annulus between the skin layers 12 and 13. The co-extrudate 75 leaves the high-pressure zone of the extruder and exits the extruder mouth and 72 into atmospheric pressure. At that point, the blowing gas 18 within the core polymer 11 expands and forms small bubbles or cells and 76. This causes the co-extrudate 75 to grow in thickness between the two skin layers 12 and 13. Normally, at the high temperatures necessary to extrude polymers such as polyurethane or polystyrene, if atmospheric gases such as carbon dioxide or nitrogen are used as physical blowing agents, the diffusivity of the polymers would allow the gases to escape to the atmosphere and would result in ineffective foaming, undersized bubbles, and non-uniformity and unpredictability of the bubble formation and size. However, because of the presence of the skins 12 and 13 on inside surface and/or the outside surfaces of the cylindrical co-extrudate 75, and because there is no open lateral edge, the gases are sealed into the core polymer 11 while the core polymer 11 is molten, so that extremely desirable cell formation, as to size, uniformity, and shape, is achieved. In the preferred embodiment, the core polymer 15 is selected to have a high degree of strain hardening so that, as the bubble 77 grows to its optimum size, strain hardening causes the bubble wall to have reduced stretching capability so that further expansion of the bubble above the optimum size is restricted or stopped. Thus, by carefully selecting the core polymer 15 and the effective blowing gas, very uniform cells of predictable size can be achieved. The cylindrical co-extrudate 75 is placed the tension and drawn by drawing rolls represented by arrows 78 and 79. The cylindrical co-extrudate 75 is drawn over an enlarged mandrel 41 which causes the cylindrical core extrudate 75 to expand the diameter all the co-extrudate 75. The mandrel 41 feeds cooled gas into the interior of the co-extrudate 75 by means of input ports 81 and 82, represented by arrows. The cooled gas exits around the outer edges of the mandrel 41, forms a cushioning layer to separate the inside of the cylindrical extrudate 75 from the mandrel 41, and it is removed by exhaust ports 85 and 86, represented by arrows.

The cylindrical core extrudate 75 is exposed to varying degrees of tension, caused by downstream drawing rollers, and the expansion effect all the mandrel 41, in order to control the thickness of the laminate, control the thickness of the skin surfaces, and to affect the properties of the laminate by exposing the layers to lateral stretching and polymer orientation, caused by the mandrel 41, and longitudinal stretching and polymer orientation, caused by the drawing rollers. After the mandrel 41 has performed its function of cooling the co-extrudate 75, of expanding the diameter of the co-extrudate 75, and laterally orienting the polymers in the co-extrudate 75, the cylindrical co-extrudate may be slit and flattened as described above.

Further Details

This invention identifies the product and process to produce a polypropylene foam core co-extrusion structure with enhanced properties. This patent identifies a multi-layered composite structure utilizing a foamed polypropylene core with additional layers of foamed or solid polypropylene or other thermoplastic or thermoset materials. The structure is in the form of a flat sheet produced by an extrusion process with an annular, circular, die forming a tube which is slit to lay flat. Though the foam or foamed core of the structure can be foamed with chemical blowing agents, or physical blowing agents of either hydrocarbon and/or inorganic types, or combination of either types and/or both types, the preferred foaming agent is carbon dioxide with a nucleating agent. The end use of the composite structure will predicate if a foam sheet alone or a structures with the numbers of and the composition of the layers in the structure.

This invention provides for a polypropylene foam material consisting of a foamed polypropylene core with a skin simultaneously extruded onto one or two sides of the core.

This invention has a polypropylene foam core having a stiff, lighter weight than solid polymer, cellular structure enhanced with a skin to help prevent flexing and crushing of the cellular structure which then provides greater stiffness to the composite structure.

In addition to the rigidity imparted by them, the skin or skins can provide such characteristics including but not limited to preferred aesthetics, barrier properties, physical property enhancement, and weight and/or cost savings to a final construction. In addition to the aforementioned attributes, this polypropylene foam material consisting of a foamed polypropylene core with a skin simultaneously extruded onto one or two sides of the core, can provide an improvement in processing time, and/or cost savings in a subsequent thermoforming operation as a thermoformable construction. The skin or skins of the polypropylene and/or alternative polymer layers for specific barrier or other physical properties are co-extruded on the structure that has a solid or more preferably foamed composition. Thin skins or single or multiple thin layers are preferably of solid composition but can be foamed. Foaming of the skin or of a single or multiple layers of skins can be effected by physical or chemical foaming agents or a combination of both. However, there is a preference for a foamed skin for skins of thickness greater than 0.002″ to prevent collapse of core foam.

The skin of the polypropylene foam co-extruded material can be made of the same or a different polypropylene or blend of polypropylenes or a polymer or blend of polymers other than polypropylene for specific desired characteristics. Depending upon desired characteristics, the skin can be of a single layer or a multiple layer construction. An example of a multiple layer construction is for use in Modified Atmosphere Packaging [MAP] where barrier films may need to be joined to the foam core or other layers by an assisting tie layer for bonding. Similarly another layer may need to be added to the surface to provide acceptability for food contact.

The utilization of the co-extrusion process for the addition of surface skin or skins provides an improvement over laminate construction of multi-layer skinned foamed composition. Advantages such as fewer inventories of raw materials, fewer processes or steps to produce a final product, and labor savings.

This invention calls for the utilization of a plastics extruder, such as a twin screw extruder, a tandem single screw extruder, or more preferably a co-rotating twin screw extruder in line with a single cooling extruder to melt into plastic state, mix the polypropylene polymeric composition, incorporate physical and/or physical and chemical blowing agents along with appropriate nucleators and/or additives to produce a foamable mass upon exit of the extruder through an annular die. An annular die is utilized in this invention to provide greater uniformity of expansion and formation of the cell structure of the foam core. This invention also calls for the use of a co-extrusion annular die to permit the simultaneous extrusion of a skin or skins onto the outer and/or inner surface of the annular extrusion.

This invention also identifies the preferred slitting of the tubular co-extrusion into a sheet configuration. This invention identifies the preferential use of co-extruded polypropylene foam core with skin or skin as a preferred material for varied applications. This applications include but are not limited to enhanced stiffness for packaging materials with lower weight packaging construction, utilization in MAP [Modified Atmosphere Packaging], self serve microwavable heating containers, water resistant non-cardboard packaging construction, etc.

This invention does not however prevent the use of the tubular construction to remain as a tube and be used for subsequent construction thereafter.

Features and Details

A polypropylene foam co-extruded material and a method utilizing an extruder and an annular die to produce the same.

A polypropylene foam material consisting of a foamed polypropylene core with a skin simultaneously extruded onto one or two sides of the core which can provide enhanced characteristics including but not limited to: barrier properties, slip or non-slip properties, physical property enhancement, a weight and/or cost savings to a final construction, etc.

A polypropylene foam material consisting of a foamed polypropylene core with a skin simultaneously extruded onto one or two sides of the core which can provide property enhancement, a weight, processing time, and/or cost savings to a thermoformable construction.

The skin or skins of the polypropylene co-extruded structure having a solid or more preferably foamed composition.

The skin of the polypropylene co-extruded structure being of multiple layer construction, from 1 to 7 layers dependent upon application on a or both sides of the extruded sheet.

The polypropylene foam core of the polypropylene foam co-extruded material having a density in the range of 1.5 PCF to 40 PCF.

The skin or skins of the polypropylene foam co-extruded material having a density in the range of 20 PCF to approximately 60 PCF, solid material.

The polypropylene foam core of the polypropylene foam co-extruded material made of neat polypropylene or blend of polypropylenes.

The polypropylene foam core of the polypropylene foam co-extruded material of a polypropylene or blend of polypropylenes and/or silane modified polyethylene or polyethylenes.

The polypropylene foam core of the polypropylene foam co-extruded material of polypropylene or blend of polypropylenes with metallocene based polypropylene or polyethylene.

The polypropylene skin of the polypropylene foam co-extruded material made of neat polypropylene or blend of polypropylenes.

The polypropylene skin of the polypropylene foam co-extruded material made of a blend of polypropylenes with metallocene polypropylene or metallocene polyethylene or polyethylenes.

The polypropylene skin of the polypropylene foam co-extruded material made of a blend of polypropylenes with silane modified metallocene polyethylene or polyethylenes.

The skin of the polypropylene foam co-extruded material made of a polymer or blend of polymers other than polypropylene for specific desired characteristics.

The polypropylene foam core of the polypropylene foam co-extruded material foamed by a physical blowing agent or agents.

The polypropylene foam core of the polypropylene foam co-extruded material foamed by a chemical blowing agent or agents.

The polypropylene foam core of the polypropylene foam co-extruded material foamed by a physical and chemical blowing agent or agents

The polypropylene foam core of the polypropylene foam co-extruded material having an additive material including but not limited to an organic, inorganic, granular, powdered, crystalline, or fibrous nature.

The polypropylene foam core of the polypropylene foam co-extruded material having an additive material to act as, including but not limited to, a nucleator for foaming, reinforcement for foaming or final properties, antioxidant, ultraviolet inhibitor, conductivity enhancement, slip or anti-slip properties.

The polypropylene skin of the polypropylene foam co-extruded material having an additive material including but not limited to an organic, inorganic, granular, powdered, crystalline, or fibrous nature.

The polypropylene skin of the polypropylene foam co-extruded material having an additive material to act as, including but not limited to, a nucleator for foaming, reinforcement for foaming or final properties, antioxidant, ultraviolet inhibitor, food and/or drug application requirements, conductivity enhancement, slip or anti-slip properties.

The polypropylene skin of the polypropylene foam co-extruded material foamed by a physical blowing agent or agents.

The polypropylene skin of the polypropylene foam co-extruded material foamed by a chemical blowing agent or agents.

The polypropylene skin of the polypropylene foam co-extruded material foamed by a physical and chemical blowing agent or agents.

The polypropylene foam core of the polypropylene foam co-extruded material being preferably from 0.020″ thick to 0.500″ thick, preferably 0.120″ thick.

The polypropylene skins of the polypropylene foam co-extruded material being preferably from 0.0002″ thick to 0.020″ thick, preferably 0.001″ thick.

The polypropylene skins of the polypropylene foam co-extruded material being preferably of equal thickness though not of necessity and capable of being of unequal thickness.

The use of a plastic extrusion system consisting of, but not limited to a single or multiple plastic extruders for melting, mixing, and incorporating additives and foaming agents, a pressurizing device to provide consistent flow and pressure to an extrusion die and the preferred extrusion die to produce a propylene foam core co-extruded material.

The use of an annular, that is, circular extrusion die construction to produce a polypropylene foam core co-extruded tubular structure.

Slitting and processing of the polypropylene foam core co-extrusion tubular structure into a flat sheet.

The materials utilized with the processes identified in this invention for producing an economical polypropylene foam are unique to this disclosure. This invention identifies the direct foaming of polypropylene by CO2 or combinations of CO2 with inorganic or organic foaming agents in a preferred material. Though various gases can be alone or in combination to permit foaming, this invention prefers the use of CO₂ alone. The preference for CO₂ alone also provides for environmentally friendly applications and food contact use. In addition to CO_{2,} the use of a nucleator, preferably a citric acid/sodium bicarbonate composition such as CF-40 or CF-20 is desired. The preferred polymer for the foam is a high melt strength polypropylene, HMS-PP, such as are available from companies as Chisso, Basell, and Borealis. HMS-PP are specifically designed for increased melt extensibility providing for stable cell growth improving foaming with physical blowing agents. Though, foam can be produced with HMS PP alone, this invention prefers the use of Borealis Daploy WB130HMS, or an equivalent modified by blending with another polypropylene. The preferred polymer for the foam, and/or core if a structure is preferred, is a high melt strength polypropylene, HMS-PP, such as the Borealis Daploy WB130HMS, or an equivalent. Typical properties of the WB130HMS include: Melt Flow rate of 2.5 g/10 min; Tensile at yield of 40 Mpa; Elongation at yield of 6%; Flexural modulus of 1900 Mpa, and a Heat Deflection temperature for 0.45 Mpa of 57.4 C and for 1.80 Mpa of 105 C. However, though 100% HMS-PP can be used for the foam or core, a more preferred composition for the foam or core is a blend of the HMS PP with a copolymer and/or homopolymer PP for improved properties of the foamed material. A preferred blend would include from 20% to 60% of the HMS PP and 80% to 40% of a copolymer and/or homopolymer. A more preferred blend would include from 40% to 50% of the HMS PP and 60% to 50% of a copolymer and/or homopolymer. An example of a preferred resin for blending with the HMS-PP for product improvement is Dow Chemical's 7c50, a high impact copolymer polypropylene, or an equivalent. Typical properties of the 7c50 are: melt flow rate (230 C) 8.0 g/10 min; tensile at yield 3330 PSI [23 Mpa]; elongation at yield 7%; and heat deflection for 0.45 Mpa pf 85 C. When the alternate copolymer and/or homopolymer polypropylene is increased relative to the HMS content, the resin of choice is a lower melt flow resin. In addition to the improvement of foaming by the blend, the final foam properties are improved. These include but are not limited to impact and cold crack performance characteristics that are needed for food packaging and automotive requirements. This criteria for performance demonstrates the desirability of the blended composition as the high melt strength polypropylene alone has not met automotive requirements for −30 C low temperature impact performance. The foam also permits a 60 to 70 percent weight reduction for a thermoformed part replacing injection or blow molded parts particularly for automotive applications. In addition to the improvement in performance characteristics a cost savings is realized by the addition of the alternate lower cost polypropylene to the more costly high melt strength material.

There are those in the industry, including the patentees, who are knowledgeable in the art of cross linking with various materials as peroxides, silanes, MAH modified polymers, to help promote melt strength as an aid in foaming. In this invention, though cross linking is permissible, it is not imperative to provide additional cross linking of the material composition as the use of a blend of a HMS PP with a copolymer and/or homopolymer provides sufficient melt strength to produce the desired foam given the foaming process used. In the industry it is know to produce polymeric foams as a continuous sheet from a flat die or in a tubular form from an annular die with physical blowing agents with various types extruders. These extruders include but are not limited to single, counter rotating twin, co-rotating twin, planetary gear, and tandem. In addition there are alternatives in screw design, L/D ratio, mixing capability, feeding capability, and other factors which affect the capability of the extrusion process to produce acceptable foams. Though the use of other extruders is possible, in this invention, the preference is for the use of a co-rotating extruder with a 40:1 L/D. Further, this invention prefers the use of a screen with screen changer, a gear pump, and a static mixer between the extruder and die to provide uniform temperature, pressure, mixing, dispersion, and foaming of the polypropylene blend material. This invention also prefers the use of a regulated and controlled temperature die and die lips to help promote uniform heating and foaming of the extrudate upon exit of the die. Further, this invention does not require apparatus nor equipment and a process to foam at very high pressures as indicated in other patented methods such as U.S. Pat. No. 5,866,053. This also promotes an economical process for manufacture.

Though a foam sheet may be made alone, dependent upon the application, a preference may be to have an additional skin layer or multiple layers on the top and or bottom of the foam sheet. The materials used as a skin or layers of skins would be dependent upon final use requirements. For example, a copolymer polypropylene film could be put on the foam sheet [core] to help improve impact and cold temperature flexibility. Alternate materials and/or additional layers for other desired attributes including, but not limited to: gas permeation rate modification, oil resistance, low odor transmission, UV resistance, etc. This invention prefers the co-extrusion of skins onto the HMS-PP foam sheet. The final surface of the co-extrusion would be dependent upon end use application. This invention does not preclude the lamination of film or sheet as a skin or layers of skins onto the foam [core] sheet. Nor does this invention preclude the subsequent lamination of any material onto the co-extruded sheet composition. For example: A construction could include a foam core with a copolymer film co-extruded onto one side on the core. The other surface of the foam could have a co-extruded sheet of a bonding layer of an alternate polymer, such as a MAH modified PP or EVA. The copolymer film would help to impart improved physical properties and cold impact resistance, while the MAH-PP would subsequently aid in the bonding of the foam composite structure to other materials, including but not limited to thermoplastics, metals, urethanes, and various density urethane foams. Another example could include multiple layer skins onto the foam core. A layer of EVOH could be one of multiple co-extrusions.

For specific applications, the construction of the foam structure would be tailored for to meet specific criteria. For example, for food use, resin choice and blends would be made to permit foaming, while giving strength in a thermoforming process, but providing cold impact resistance for and higher temperature resistance for microwavable frozen food applications. Additional layers could be include in an example of this type to provide resistance to moisture or gas permeation, odor retention or elimination, etc.

Applications of this invention can be in many diverse industries. In automotive and other industries as well, the advantage of this invention is observed in the improvement in economics. This is demonstrated in part fabrication by thermoforming in place of injection or blow molding, and/or by the weight reduction of an individual part by as much as 70% by replacing a solid plastic structure with a foam or foam core composition that meets performance characteristics. The economics are further improved as there is a cost savings achieved by the use of a lower cost copolymer and/or homopolymer polypropylene resin replacing the higher cost HMS polypropylene resin. The economics of manufacturing are further improved by the use of a physical foaming agent to give a more uniform cell structure at a lower cost than that which has been historically achieved by a chemical blown polypropylene foams.

Similarly, dependent upon end use, a foam core structure can have its properties further enhanced by the selection of material or materials for each skin layer improved. Co-extrusion can be used to produce a foam core structure can be accomplished in an A-B, or A-B-A, or A-B-C composition for additional performance characteristics. Here B is the blended PP foam core and A and/or C are materials of choice for particular applications. The A and/or C segment of the structures can also be a single or multiple layer of materials as a composite skin dependent upon desired end use. For example, additional strength could be given to a part by the addition of skins in an A-B-A combination simulating the strength achieved by an I-bean construction while having a reduction in weight. An alternate example could be an A-B-C construction where C could be a 2 or 3 layer construction having one segment of layer of A composition along with layers of other materials. Such would include a food packaging application which could have one skin surface of a polypropylene copolymer to improve cold impact strength and the other skin surface of a layer composition of polypropylene and other materials to improve cold impact strength and also barrier properties. Further either or both of the skins of the core construction can be solid or foam or combined foam and solid composition. Should foaming of either or both skin be desired, the preference is for the use of a chemical blowing agent.

None of the known prior art teach or suggest the novel and inventive principles of my invention which accomplishes these separate functions in a way not heretofore recognized in the field of formation of polymer foam core laminates.

Variations

The co-extruded layer or layers [single or multiple] may have conductive, anti-static, an/or static dissipative properties, in particular for use in electrical, computer, and/or automotive equipment or packaging.

Similarly with the foam core, the co-extruded layer or layers can be of EVA (ethylene vinyl acetate) solid or foam layer, can have multiple layer construction with conductive layer on one or both layers, thus giving a soft touch, but also having the capability for static dissipation

The laminate can have a foam core with foam EVA alone on top and/or bottom to prevent marring or scratching for use as separators, totes, etc., and for such items as Class A automotive surfaces or fine China, which can be die cut or thermoformed to produce a specific shape or part.

Similarly additives such as anti-microbial, odor absorbers, colorants, etc., can be added into either or both of the co-extruded layers, and there can be multiple layers to provide multiple benefits to the composition and structure.

Foam Profiling Air Ring

It is known in the art to use a forming mandrel equipped with an air source to form a foaming bubble in between the die and the mandrel to produce a tubular structure which is subsequently slit and opened up to produce a flat sheet. What is not apparent to those known in the art is the use of a Foam Profiling Air Ring to improve the product and process of a foam extrusion.

In conjunction with the forming mandrel 41 for a foaming extrusion line, there are three basic objectives for the use of a Foam Profiling Air Ring:
1. Profile the foaming bubble to conform to a specific shape to help achieve a flat sheet free of corrugations
2. Help to support a foamable weak melt extrudate for uniform gauge and ease in processing
3. To enhance cooling on the inside surface of the extrudate, whether it is foamed or a skin or a part of an ABA or multiple layer construction

The Foam Profiling Air Ring is a multi-lipped ring piece of equipment at the upstream end of the mandrel 41. It provides cooling air to the inside of the foaming bubble in the extrusion process through input ports 81 and 82, while also having vacuum capabilities to permit air evacuation from inside the bubble, through exhaust ports 85 and 86. This dual function of the input of and removal of air provides the capability to maintain any specified temperature and/or pressure required by the process for any specific material.

The Multi-Lip Design Provides:

Cooling air at multiple impingement points along the flow of material over the air ring that will propagate and maintain a continuous air bearing over the air ring and mandrel.

The vacuum capability of this device allows for the removal of heated air from inside the bubble and is designed to work in conjunction with the cooling air input from the multiple lip construction to maintain a specified temperature and/or pressure of the internal bubble while maintaining bubble stability.

Blowing Agents

Physical blowing agent comparison overview:

CO2
Naturally occurring atmospheric gas
Environmentally friendly
Low cost
Non burning
Fast aging/equilibration time
More soluble than N2
Will produce a cell larger than N2
N2
Naturally occurring atmospheric gas
Environmentally friendly
Low cost
Non burning
Will produce fine cell
Tends to produce more corrugations than CO2
Hydrocarbons
Lower vapor pressure provides greater solubility
Permits staying in solution longer which aids in making less corrugations
Provides a more controlled foaming in the foaming process
Reduces viscosity of plastic melt providing higher output at lower temperatures with less shear on screw and less work loss
Is flammable
Is potentially explosive
Not environmentally friendly
Requires aging time for equilibration of internal and external gases
Requires additional permits and emissions controls

Any specific gas can be used dependent upon desired benefits, ie. non-burning, fine cell, low cost, etc. Blends of the above are used to maximize benefits and minimize detriments of using any single gas for foaming.

It is obvious that minor changes may be made in the form and construction of the invention without departing from the material spirit thereof. It is not, however, desired to confine the invention to the exact form herein shown and described, but it is desired to include all such as properly come within the scope claimed.

While my invention has been described with reference to a particular example of a preferred embodiment, it is my intention to cover all modifications and equivalents within the scope of the following claims. It is therefore requested that the following claims, which define my invention, be given a liberal interpretation which is within the spirit and scope of my contribution to this art of lobster fishing.

1. A multilayer polymeric structure formed from a co-extrudate of a foamable core composition and a first skin extrudate layer joined to a first surface of said prefoamed core composition and a second extrudate layer joined to a second surface of said prefoamed core composition which comprises:
(a) a foamed core formed from said foamable core composition and comprising a polymer having cells filled with a gas, said first surface and said second surface, and
(b) a first polymeric skin layer formed from said first skin extrudate layer joined to said first surface and a second polymeric skin layer from said second extrudate layer joined to said second surface.

2. The structure of claim 1 having a cylindrical shape.

3. The structure of claim 1 having a flat shape.

4. The structure of claim 1 wherein said first polymeric skin layer and said second polymeric skin layer have the same composition.

5. The structure of claim 2 wherein said first polymeric skin layer and said second polymeric skin layer have the same composition.

6. The structure of claim 3 wherein said first polymeric skin layer and said second polymeric skin layer have the same composition.

7. The structure of claim 1 wherein said first polymeric skin layer and said second polymeric skin layer have a different composition.

8. The structure of claim 2 wherein said first polymeric skin layer and said second polymeric skin layer have a different composition.

9. The structure of claim 3 wherein said first polymeric skin layer and said second polymeric skin layer have a different composition.

10. The structure of claim 1, wherein said foamed core is formed of polypropylene.

11. The structure of claim 1, wherein said foamed core is formed of polystyrene.

12. The structure of claim 1, wherein at least one of said skin layers contains an additive.

13. The structure of any one of claim 12 wherein at least one of said skin layers contains an additive selected from the group consisting of an organic additive, an inorganic additive, a granular additive, a powdered additive, a crystalline additive and a fibrous additive.

14. The structure of claim 12 wherein said core is formed of polypropylene.

15. The structure of claim 13 wherein said core is formed of polypropylene.

16. The structure of claim 12 wherein said core is formed of polystyrene.

17. The structure of claim 13 wherein said core is formed of polystyrene.

18. The structure of claim 1, wherein at least one of said skin layers is solid.

19. The structure of claim 1, wherein at least one of said skin layers is a foam.

20. The structure of claim 18 wherein said core is formed of polypropylene.

21. The structure of claim 19 wherein said core is formed of polypropylene.

22. The structure of claim 18 wherein said core is formed of polystyrene.

23. The structure of claim 19 wherein said core is formed of polystyrene.

24-26. (canceled)

27. A method for forming a multilayer polymeric structure which comprises:
(a) mixing a first polymer with a blowing agent to form a foamable composition having a first surface and a second surface and
(b) co-extruding said foamable composition with a second polymer composition and with a third polymer composition to form a co-extrudate comprising: (1) a foamed core having said first surface and said second surface, (2) a first skin layer formed of said second polymer composition joined to said first surface and (3) a second skin layer formed of said third polymer composition joined to said second surface.

28. The method of claim 27 wherein said blowing agent is a composition selected from the group consisting of a chemical blowing agent, a physical blowing agent and mixtures thereof.

29. The method of claim 27 wherein said co-extrudate has a cylindrical shape.

30. The method of claim 28 wherein said co-extrudate has a cylindrical shape.

31. The method of claim 27 wherein said co-extrudate has a flat shape.

32. The method of claim 28 wherein said co-extrudate has a flat shape.

33. The method of claim 27, wherein said first polymer is polypropylene.

34. The method of claim 27, wherein said first polymer is polystyrene.

35. The method of claim 29 wherein said cylindrical co-extrudate is slit to form an open sheet.

36. The method of claim 30 wherein said cylindrical co-extrudate is slit to form an open sheet.

37. The method of claim 35 wherein said first polymer is polypropylene.

38. The method of claim 36 wherein said first polymer is polypropylene.

39. The method of claim 35 wherein said first polymer is polystyrene.

40. The method of claim 36 wherein said first polymer is polystyrene.

41. The method of claim 27 wherein said second polymer composition and said third polymer composition are the same.

42. The method of claim 28 wherein said second polymer composition and said third polymer composition are the same.

43. The method of claim 29 wherein said second polymer composition and said third polymer composition are the same.

44. The method of claim 30 wherein said second polymer composition and said third polymer composition are the same.

45. The method of claim 31 wherein said second polymer composition and said third polymer composition are the same.

46. The method of claim 32 wherein said second polymer composition and said third polymer composition are the same.

47. The method of claim 33 wherein said second polymer composition and said third polymer composition are the same.

48. The method of claim 34 wherein said second polymer composition and said third polymer composition are the same.

49-94. (canceled)
